(19) United States
(12) Patent Application Publication
(10) Pub. No.: US 2021/0002496 A1
(43) Pub. Date: Jan. 7, 2021

(54) METHOD FOR PRODUCTION OF A COATING

(71) Applicants: Battrion AG, Luzern (CH); HILTI Aktiengesellschaft, Schaan (LI)

(72) Inventor: Max Kory, Zurich (CH)

(21) Appl. No.: 16/968,667

(22) PCT Filed: Feb. 11, 2019
(86) PCT No.: PCT/IB2019/051071

§ 371 Date: Aug. 21, 2020

(30) Foreign Application Priority Data
Feb. 28, 2018 (CH) 00238/18

(51) Int. Cl. C09D 5/26; H01M 4/587; H01M 4/62; H01M 10/0525; H01M 4/133

(52) U.S. Cl. CPC C09D 5/26; H01M 4/587; H01M 4/622; C08K 3/04; H01M 4/133; C08K 2201/01; H01M 10/0525

(57) ABSTRACT

Processes and apparatus for production of coatings applicable particularly for manufacture of electrodes, and more particularly for the manufacture of electrodes for use in lithium-ion batteries. Coatings may be produced from thermoresponsive pastes that contain solids particles and a thermoresponsive component, the coating or layer being coated on a carrier, solidified and dried; and wherein less than 80% of a volatile solvent component is removed from the coating during solidification.

This application is a 35 U.S.C. 371 national-phase entry of PCT International application no. PCT/IB2019/051071 filed on Feb. 11, 2019 and also claims benefit of priority to prior Swiss national application no. CH 00238/18 filed on Feb. 28, 2018, and parent PCT International application no. PCT/IB2019/051071 is integral with this present U.S. national phase entry application.

### SUMMARY

The present disclosure relates to a coating production method that is applicable particularly for the manufacture of electrodes, and further especially for the manufacture of electrodes for use in lithium-ion batteries.

Pastes, particularly pastes consisting of carbon-based materials, especially graphite, or pastes that particularly contain metal oxide particles are used for the manufacture of battery electrodes.

To manufacture the negative electrode, an aqueous suspension of graphite particles with carboxymethyl cellulose (CMC) is mixed and afterwards, a styrene-butadiene rubber latex binder (SBR-binder) is added. The CMC has two functions. On the one hand, as a surface modifier, it ensures that the graphite particles can be dispersed well in water, and on the other hand, it acts as a rheology modifier. In this second role, the CMC chains ensure that the resulting suspension forms a stable viscous paste that manifests little sedimentation and simultaneously has, at high shear rates, sufficiently low viscosity to ensure a bubble-free application, via a slot nozzle, to a carrier foil.

The SBR binder ensures that the applied coating adheres to the carrier foil and that the coating has sufficient elasticity.

Depending on the shape of the graphite particles which are used here, various solids contents may be obtained in the paste. Spherical particles can ordinarily produce a higher solids content. In general, a high solids percentage is of interest, since this can be dried faster and more energy-efficiently.

In order to increase the charging and discharging rates of a lithium-ion battery, the graphite particles of a negative electrode can, at its manufacture, be aligned. In the process, an adhesive layer is first applied to the foil carrier (copper foil), and then, the graphite particles in the paste are aligned vertically to the foil carrier. Subsequent drying results in a negative electrode with vertically aligned graphite particles.

In the conventional manufacture of negative electrodes for application in lithium batteries, undesired migration of the SBR binder occurs during drying of the wet coatings. Especially if the applied paste is dried quickly, i.e. under high temperatures and with an intense air flow, the SBR binder particles move to the surface of the coating (Langmuir, 2013, 29 (26), pp. 8233-8244). This process can occur due to convection of the solvent, in this case water. Thus, in the finished dried electrode this results in a deficiency of the SBR binder at the interface between the copper foil and the graphite coating. This can lead to poor adhesion of the coating on the foil carrier. That can adversely impair the electrochemical performance of a lithium-ion battery thus manufactured. Therefore, in order to avoid binder migration in wet coatings, the industry mostly uses gentle drying conditions with low temperatures and low air flow. However, this leads to an undesirable slowdown of the electrode manufacturing process.

Some pastes to be used for coatings contain non-spherical particles. Pastes that contain anisotropic particle shapes often achieve only low solids contents. Pastes with flake-like particles such as, for example, non-rounded, flake-shaped graphite represent an example of this. With these pastes, the low solids content can lead to occurrence of a pronounced convection which, during drying, can carry particles inside of the coating away. This process can lead to inhomogeneous coating weights per unit area of the coating. Furthermore, at low coating weights per unit area, the drying process can also lead to cracks in the coating. The production of quickly-charging and discharging lithium-ion batteries with vertically (i.e., perpendicular to the current collector foil) aligned flake-form graphite particles poses a particular challenge in this context. The pastes that are used for this purpose often contain a low solids content due to the plate-like flake form of the particles. The vertical alignment of the graphite particles also favors the formation of cracks. Furthermore, the vertical alignment of the particles can lead to more intense convection during drying, thereby increasing binder migration, which can lead to poor adhesion of the coating to the foil carrier. An intense convection can also result in loss of the vertical alignment of the graphite particles during drying. Also, an intense air flow from the dryer can adversely affect the vertical alignment of the particles.

Another problem in the manufacture of negative electrodes for use in lithium batteries is irregular coating weights per unit area in proximity of the edges of the coatings, especially with intermittent coatings.

Irregular coating weights per unit area can lead to undesired deposition of lithium on the electrodes (in contrast to the desired intercalation into the electrode particles), especially there where the coating weights per unit area are not sufficiently high. A shortened length of life, and the deposited lithium's dendritic growth which can lead to a short circuit of the battery with dangerous consequences, can result due to this deposition.

In order to solve this problem, coating edges that are produced from the manufacture of electrodes are often cut off, taped with Kapton adhesive tape, or subsequently improved by ablation. This is cumbersome and means additional extra expenses in the manufacture of electrodes.

The primary object of the present disclosure is therefore to develop, for producing a coating or layer, a simple method that can be used in particular for the production of electrodes and more particularly for the production of electrodes for use in lithium-ion batteries.

According to the present disclosure, in order to produce a coating from a thermoresponsive paste that contains solid particles and a thermoresponsive component, the coating or layer is coated on a carrier, solidified, and dried. Here, at least 0.001% and less than 80% of a volatile component is removed from the coating during solidification. The volatile component in which the solid particles are suspended is a solvent, for example water.

Further subtasks according to the present disclosure lie in developing a solidifying additive that can be added to a paste in order to impart solidifying properties to it. Furthermore, especially for use in the production of lithium-ion batteries, a paste formulation and its production are to be developed.

Additionally, there is to be developed an electrode produced with this paste.

A method according to the present disclosure makes it possible to transform a conventional paste into a thermoresponsive paste with which better coatings may be obtained. This may be achieved by the addition of the thermoresponsive additive to a conventionally produced paste, i.e. to a paste that contains no solidifying constituent.

The present disclosure enables a faster drying of coatings that contain solid particles, because it, as a result of the solidifying/thermoresponsive properties of the paste, inhibits binder migration.

Moreover, as a result of the solidifying, i.e. reinforcing, properties, the present disclosure enables homogenous coating weights per unit area even in the case of coatings made of pastes that contain a low solids percentage.

Furthermore, as a result of the solidifying, i.e. reinforcing, properties, the present disclosure enables a fixing of aligned particles and, in this manner, prevents the orientation of the particles from being adversely affected during the drying process. Additionally, the present disclosure herein improves, as a result of the solidifying, i.e. reinforcing, properties, the homogeneity of the coating weights per unit area in proximity of the edges of the coating.

### BRIEF DESCRIPTION OF THE DRAWINGS

In following are described several exemplary embodiments with reference to drawings. In the drawings are shown:

FIG. 1: a temperature-viscosity graph, and

FIG. 2: the construction of a device for solidification of a paste.

### DETAILED DESCRIPTION

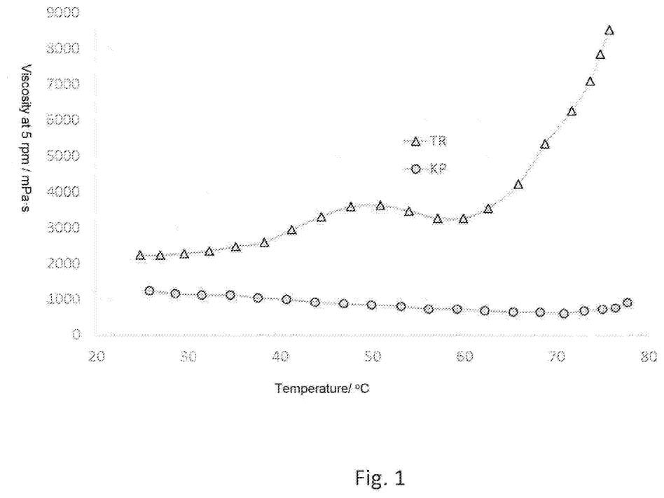

FIG. 1 shows a graph that illustrates the temperature-viscosity relationship in the case of a conventional paste KP and also that of a thermoresponsive paste TR. The viscosity of the respective paste was measured using a Brookfield rheometer (spindle size 4, at 5 rpm). While the conventional paste KP becomes less viscous as the temperature rises, the viscosity of the thermoresponsive paste TR increases.

During a drying phase of coatings with pastes that contain solid particles, convection occurs within the coating. Particles from SBR binders can be transported to the coating surface by this flow transport that occurs particularly strongly in the case of fast drying processes having high temperatures and high air flow. This process can occur due to convection of the solvent, in this case water. Thus, in the finished dried electrode this results in a deficiency of the SBR binder at the interface between the copper foil and the graphite coating. This can lead to poor adhesion of the coating on the foil carrier 030 (FIG. 2), which can adversely impair the electrochemical performance of a lithium-ion battery so manufactured.

By the present disclosure, this problem may be solved by the application of a solidifying/gelling component, for example a thermoresponsive component, that is included within the paste to be coated. Under the action of heat, this constituent, for example methylcellulose, causes the applied wet coating/layer to solidify without simultaneously removing the volatile component. Here, the LCST (Lower Critical Solution Temperature) plays an important role. An LCST is often observed when polymers such as, for example, methylcellulose or hydroxypropyl cellulose, that contain substituted and unsubstituted anhydroglucose rings; or when polymers such as poly (N-isopropylacrylamides) are constituents of the mixtures. At the same time, a transition of the polymer chains from an open-chain coil conformation to a compact conformation can be observed. Above the LCST there exists a miscibility gap that can lead to the solidification of the coating/layer. In the process, the heat required to get above the LCST can come from heating elements 040 (FIG. 2) such as, for example, heated blowers, heated (cylindric) rolls, infrared radiant heaters, heating LEDs, microwave devices, induction heating devices or combinations thereof. In the example, a respective heating element 040 is arranged above and below the foil carrier 030.

Even small weight percentages of the thermoresponsive component, such as, for example, 0.25% by weight in the layer to be coated (corresponds to 0.5% by weight in the resulting dry coating in the case of a solids content weight percentage of 50% of the layer to be coated), are sufficient in order to induce solidification of the paste at rise of temperature above of the LCST.

The increased viscosity in the coating leads to reduction of flow transport of the SBR binder particles during drying. In this manner, a decreased concentration of the SBR binder particles at the interface with the coating carrier foil does not occur. This results in a good adhesion of the coating even with rapid drying (high temperatures, intense airflow). This means a speeding up of the electrode manufacturing process compared to conventional drying under milder conditions.

Coatings made from pastes with a low solids percentage pose a further problem, since, likewise here, there occur strong transport flows during the drying phase. In the process, the strong transport flows can lead to an inhomogeneous coating weight per unit area (see Table 1, electrode type 3). By use of a solidifying/gelling component, such as, for example, a thermoresponsive component contained in the paste to be coated, the transport flows are decreased.

TABLE 1

| | | Standard Devia- | | |
|---|---|---|---|---|
| | | tion of Coating | | |
| | | Weight per unit | | |
| | | area (estab- | | |
| Elec- | Paste Type for | lished from 3 | Porosity | Density |
| trode | Electrode Manufacture | samples) (%) | (%) | (g/cm³) |
| 1 | conventional paste with | 1.5 | 57 | 0.98 |
| | flake-form graphite | | | |
| | (proport. solids: 47 wt. %) | | | |
| 2 | thermoresponsive paste | 2.0 | 60 | 0.89 |
| | with flake-form graphite | | | |
| | (proport. solids: 47 wt. %) | | | |
| 3 | conventional paste with | 14.7 | 61 | 0.87 |
| | natural flaky graphite | | | |
| | (proport. solids: 36 wt. %) | | | |
| 4 | thermoresponsive paste | 1.6 | 70 | 0.67 |
| | with natural flaky | | | |
| | graphite | | | |
| | (proport. solids: 36 wt. %) | | | |

Table 1 shows the influence that the thermoresponsive component A in the paste has on the porosity and homogeneity of an electrode made therefrom. For this purpose, three samples were punched out of the electrode and characterized with regard to coating weight per unit area and thickness. Electrodes which were made from a thermoresponsive paste exhibit higher porosities/lower densities. Electrodes that were produced with thermoresponsive pastes TR with a low solids percentage show more homogeneous coating weights per unit area than do electrodes that were produced with conventional pastes KP with low solids percentage.

The increased porosities and the homogeneous coating weights per unit area of the electrodes that were manufactured with thermoresponsive pastes TR indicate that the particles contained in the paste are fixed by the thermoresponsive component A.

The use of solidifying pastes also has advantages in the case of coatings with aligned particles. The drying process that takes place after alignment of the particles in a field can, in the process, lead to undesirable change of orientation of the aligned particles. In particular, air drying in the oven by blowers can have a significant influence on the orientation of the aligned particles, in particular because the vertical alignment of graphite particles that was produced by action of a magnetic field (magnetic field device 050) can be affected during drying in the dryer 020. Losing the alignment of the graphite particles can, in turn, lower the electrochemical performance of the electrode during charging and discharging. The use of a solidifying component can avoid disturbance of the orientation of aligned particles.

In the case of graphite particles, the alignment that was previously accomplished in the magnetic field can be preserved long-term by solidifying the moist coating. This allows the subsequent drying to be executed without application of a magnetic field, since movement within the coating, for example by convection, is prevented, and the constituents cannot change their orientation.

By using a hardening additive, for example a thermoresponsive additive that may include, exemplarily, methylcellulose and additionally a silicone-based antifoam agent B, conventionally produced paste can, through simple admixing, also be converted into a thermoresponsive paste. In this manner, improvements in the electrode properties can also be realized without costly adjustments. Addition of the thermoresponsive additive to a paste can cause a thickening of the paste when mixed. In the process, it has appeared that the order of addition of the additive plays an important role. If the thermoresponsive additive is added after the addition of the SBR binder, solidification of the paste at stirring is minimized.

The use of thermoresponsive components A, such as for example methylcellulose, can lead to air inclusions (bubbles and foam generation). Pastes including such a thermoresponsive component can therefore likewise exhibit a tendency towards inclusion of trapped air. In the case of coatings, defects can occur from such air inclusions. It is imperative to avoid this. By addition of an antifoam agent B, for example a silicone-based antifoam agent B, air inclusions can be avoided efficiently. Since the addition of an antifoam agent B may also lead to defects in the coating, the concentration and type of the antifoam agent B is important. In the process, it is important to keep the quantity of added antifoam agent B as low as possible.

Another aspect according to the present disclosure relates to the admixing of another kind of solid particle additionally to the active material present as the main constituent in the thermoresponsive paste. In the particular case where the particle sizes of the solid materials differ, higher solid concentrations can be obtained in this case. This is particularly helpful when flake-like graphite is employed as the active material, since by adding another type of solid particle, less water is used in the paste, which accelerates drying, and in the case of aligned graphite, can result in a better alignment of the graphite particles in the dry electrode. In the process, possible further solid particles may be a further type of graphite particle, aluminum oxide particles, silicon particles, silicon oxide particles, or similar solid particles.

A further aspect of the present disclosure relates to a device for solidifying thermoresponsive pastes TR or layers. A paste solidifying device 060 is located between a coating nozzle 010 and the dryer 020. The object of the paste solidifying device 060 is to solidify, on the foil carrier 030, the moist and fluid coating that includes a solidifying component such as a thermoresponsive component, so that the coating arrives at dryer 020 in a solidified/gelled state for subsequent drying. The paste solidifying device 060 includes heating elements 040, such as, for example, heated blowers, heated rolls, IR radiant heaters, devices for emitting microwaves, induction heating devices, or combinations thereof. Furthermore, for the alignment of particles in the paste to be solidified, the paste solidifying device 060 can also include a magnetic field device 050. This magnetic field device 050 provides the alignment of the particles in the still moist and fluid coating. The heating elements 040 then ensure the fixation of the aligned particles in the thermoresponsive paste TR. Via subsequent drying within the dryer 020, a dry coating with aligned particles can be obtained in this manner.

Improvements of the electrode properties with a thermoresponsive paste TR (better adhesion, more homogeneous coating weights per unit area, better alignment in the case of oriented particles) can in part only be achieved by application of heat from a 020 dryer, i.e. achieved without the paste solidifying device 060 described here. In this way however, the solidification of the thermoresponsive paste TP and its drying can be difficult to separate from one another. Through this, mixed effects (binder migration occurring in part, partial loss of orientation of particles, etc.) can occur.

The above-mentioned devices, as described in the exemplary embodiments, to be used according to the present disclosure are not subject to any particular special conditions as to their size, form, design, choice of materials and technical concepts, so that the selection criteria known in the field of application may be employed without restriction.

The description of FIG. 2 yields further details, objects, and advantages of the subject matter of the present disclosure. In FIG. 2, preferred embodiments according to the present disclosure are illustrated by way of example. The features that can be gathered from the description and the drawings can be used according to the present disclosure individually or jointly in any combination.

### EXAMPLES

Production of the Thermoresponsive Additive:

A mass of 1.2 g of an organo-modified silicone copolymer defoamer are mixed with 75 g of a filtered 2 wt. % methylcellulose solution in a planetary centrifugal mixer at 2000 rpm for 10 min. Any possibly included air bubbles are then removed by the mixer defoamer program.

Production of a Thermoresponsive Paste TP:

A mass of 97 g of flake-shaped graphite are kneaded with 42.5 g of carboxymethylcellulose (CMC) solution (2 wt. %) and 30.67 g of deionized water in a Planetary Centrifugal Mixer at 1200 rpm for 6 minutes. In order to obtain a good intermixing, the mixture is occasionally (i. e., from time to time) stirred by hand. Subsequently, 8.53 g of deionized water are added to the mixture and again mixed at 1200 rpm for 1.5 minutes. A mass of 5 g of a SBR latex binder (40 wt. % solids percentage) is blended to this mixture. As a final step, 17.5 g of a thermoresponsive additive (1.6 wt. % defoamer-methylcellulose mixture) is added to the mixture and mixed by hand.

Production of a Thermoresponsive Paste TP Having Two Different Solids Main Fractions:

A mass of 73 g of flake-shaped graphite are mixed with rounded off graphite and then along with 60 g of carboxymethylcellulose (CMC) solution (2 wt. %) and 57 g of deionized water kneaded in a Planetary Centrifugal Mixer at 1200 rpm for 6 minutes. In order to obtain a good intermixing, the mixture is occasionally (i. e., from time to time) stirred by hand. Subsequently, 63 g of deionized water are added to the mixture and mixed again at 1200 rpm for 1.5 minutes. A mass of 5 g of a SBR latex binder (40 wt. % solids percentage) is blended to this mixture. As a final step, 15 g of a thermoresponsive additive (2 wt. % defoamer-methylcellulose mixture) is added to the mixture and mixed by hand.

Production of a Thermoresponsive Paste TR from a Conventional Paste KP:

To a conventional paste, comprising mixture of 97 g flake-shaped graphite, 50 g carboxymethylcellulose (CMC) solution (2 wt. %) and 55 g of deionized water and 5 g of a SBR latex binder (40 wt. %), are added 17.5 g of a thermoresponsive additive (1.6% defoamer-methylcellulose mixture) and mixed by hand.

Manufacture of an Electrode Out of the Thermoresponsive Paste TR:

The so-obtained graphite paste is applied with a doctor blade as a fluid film onto a current collector foil (copper foil 15 μm). IR radiant heaters operate for solidification of the deposited coating. Subsequent drying yields a porous electrode.

Manufacture of a Vertically Aligned Electrode from the Thermoresponsive Paste TR:

The so-obtained graphite paste is applied with a doctor blade as a fluid film onto a current collector foil (copper foil 15 μm). IR radiant heaters operate for solidification of the deposited coating. Thus the vertically aligned particles are bound. Subsequent drying yields a porous electrode having vertically aligned graphite particles.

A negative electrode having vertically aligned graphite particles and manufactured with a thermoresponsive paste TR can, together with a cathode, a separator and an organic electrolyte, be used for a lithium-ion battery.

In closing, it should be noted that the above description is intended to illustrate rather than limit the invention, and that readers skilled in the technological art shall be capable of designing alternative embodiments without departing from the protected scope of invention as set forth by the appended claims. As equivalent elements or steps can be substituted for elements or steps employed in claimed invention so as to obtain substantially the same results in substantially the same way, the protected scope of the present invention is defined by the appended claims, including known equivalents and unforeseeable equivalents at the time of filing of this application. Furthermore, in the following claims, the verb ‘comprise’ and its conjugations do not exclude the presence of elements or steps other than those listed in any claim or the specification as a whole. The singular reference of an element does not necessarily exclude the plural reference of such elements and vice-versa. The mere fact that certain elements or steps may be recited in mutually different dependent claims does not necessarily indicate that a combination of these elements or steps cannot possibly be used to advantage.

### LIST OF REFERENCE LABELS

010 coating nozzle
020 dryer
030 foil carrier
040 heating element
050 magnetic field device
060 paste solidifying unit
A thermoresponsive component
B antifoam agent (defoamer)
KP conventional paste
TR thermoresponsive paste

What is claimed is:

1-16. (canceled)

17. Method for producing a coating from a thermoresponsive paste that includes solids particles and a thermoresponsive component, the coating or layer being coated onto a carrier, solidified and dried, characterized in that, less than 80% of a volatile solvent component is removed from the coating during solidification.

18. A method according to claim 17, characterized in that, the paste includes magnetically susceptible components, in particular magnetically susceptible particles, preferably magnetically susceptible carbon particles and particularly preferably magnetically susceptible graphite particles.

19. A method according to claim 17, characterized in that, the paste for layer formation is coated on a component, solidified and dried.

20. A method according to claim 19, characterized in that, the paste is used for the manufacture of electrodes.

21. A method according to claim 19, characterized in that the coating is solidified, in a continuous process, in a solidification device, wherein the device has a coating nozzle (010), characterized in that, the device comprises a paste solidifying device (060) that is arranged downstream of the coating nozzle (010) and preceding a dryer (020), and has at least one heating element (040) and a magnetic field device (50).

22. A method according to claim 21, characterized in that, the heated element (40) has heated blowers, heated rolls, infrared radiant heaters, heating LEDs, induction heating devices, microwave devices or combinations thereof.

23. Method for producing a coating from a thermoresponsive paste (TR), characterized in that, after the addition of an SBR binder to the paste, an additive which includes a thermoresponsive component is added to the paste.

24. A method according to claim 23, characterized in that the additive includes a thermoresponsive component (A), or that it includes a thermoresponsive component (A) and an antifoam agent (B).

25. A method according to claim 24, characterized in that, the thermoresponsive component (A) includes substituted and/or unsubstituted anhydroglucose rings.

26. A method according to claim 24, characterized in that, the antifoam agent (B) is silicone based.

27. A method according to claim 24, characterized in that, the ratio between thermoresponsive component (A) and antifoam agent (B) is 1:0.001 to 0.01:1.

28. A method according to claim 23, characterized in that, the additive is contained in a paste for the manufacture of electrodes.

29. Electrode characterized in that, it is manufactured from a thermoresponsive paste (TR).

30. An electrode according to claim 29, characterized in that, it includes vertically aligned graphite particles.

31. An electrode according to claim 29, characterized in that, the thermoresponsive paste contains solids particles, preferably graphite particles and a thermoresponsive component, wherein the thermoresponsive component includes substituted and/or unsubstituted anhydroglucose rings.

32. An electrode according to according to claim 31, characterized in that, the thermoresponsive paste includes an antifoam agent (B).
